(19) United States
(12) Patent Application Publication
(10) Pub. No.: US 2021/0248196 A1
(43) Pub. Date: Aug. 12, 2021

(54) INTEREST ESTIMATION DEVICE

(71) Applicant: NTT DOCOMO, INC., Chiyoda-ku (JP)

(72) Inventors: Satoshi KAWASAKI, Chiyoda-ku (JP); Takeshi KAMIYAMA, Chiyoda-ku (JP); Masato YAMADA, Chiyoda-ku (JP); Yusuke FUKAZAWA, Chiyoda-ku (JP); Masatoshi KIMOTO, Chiyoda-ku (JP)

(73) Assignee: NTT DOCOMO, INC., Chiyoda-ku (JP)

(21) Appl. No.: 17/049,721

(22) PCT Filed: Mar. 4, 2019
(86) PCT No.: PCT/JP2019/008453

§ 371 Date: Oct. 22, 2020

(30) Foreign Application Priority Data
Apr. 26, 2018 (JP) 2018-085607

(51) Int. Cl. G06F 16/9535; G06F 16/9537; G06F 16/909; G06F 16/23

(52) U.S. Cl. CPC G06F 16/9535; G06F 16/2365; G06F 16/909; G06F 16/9537

(57) ABSTRACT

An interest estimation device (1) includes: an acquisition unit (10) configured to acquire visited POI information representing a point of interest (POI) which a user visited and a visiting time at which the POI is visited; and an estimation unit (11) configured to search for one or more events that were held at the POI represented by the visited POI information acquired by the acquisition unit (10) and at the visiting time represented by the visited POI information and estimate a user's interest on the basis of a result of the search.

### TECHNICAL FIELD

It relates to an interest estimation device that estimates a user's interest.

### BACKGROUND ART

In the following Patent Literature 1, a recommended points of interest (POI) determining device that determines POIs to be recommended to a user on the basis of behavior history information including information relating to POIs which the user has visited and the like has been disclosed.

### CITATION LIST

### Patent Literature

[Patent Literature 1] Japanese Unexamined Patent Publication No. 2011-003151

### SUMMARY OF INVENTION

### Technical Problem

The recommended POI determining device described above performs a process on the premise that a user is interested in POIs which the user has visited. However, there are also cases in which a user is interested in not POIs which the user has visited but events held at the POIs which the user has visited. In other words, there is a likelihood that the recommended POI determining device may perform a process on the basis of an erroneously estimated user's interest.

Thus, it is in view of such problems, and an object thereof is to provide an interest estimation device capable of estimating a user's interest more accurately.

### Solution to Problem

In order to solve the problems described above, an interest estimation device according to one aspect of the present invention includes: an acquisition unit configured to acquire visited POI information representing a POI which a user visited and a visiting time at which the POI is visited; and an estimation unit configured to search for one or more events that were held at the POI represented by the visited POI information acquired by the acquisition unit and at the visiting time represented by the visited POI information and estimate a user's interest on the basis of a result of the search.

According to such an interest estimation device, a user's interest is estimated on the basis of POIs visited by the user and a result of a search for one or more events that were held at visiting times at which the POIs were visited. For example, in a case in which one or more events were able to be retrieved, the user may be estimated to have been interested in the one or more events, and, in a case in which no events were able to be retrieved, the user may be estimated to have been interested in the visited POI. In this way, it can be estimated whether a user is interested in one or more events or a POI or the like, and a user's interest can be estimated more accurately.

### Advantageous Effects of Invention

A user's interest can be estimated more accurately.

### BRIEF DESCRIPTION OF DRAWINGS

FIG. 1 is a functional block diagram of an interest estimation device according to an embodiment of the present invention.

FIG. 2 is a diagram illustrating an example of a table of visited POIs.

FIG. 3 is a diagram illustrating an example of a table of event information.

FIG. 4 is a diagram illustrating overlapping between event holding periods and a visiting time.

FIG. 5 is a diagram illustrating an example of a table of event preference definitions.

FIG. 6 is a diagram illustrating an example of a table of preference attributes.

FIG. 7 is a diagram illustrating an example of a table of a POI master.

FIG. 8 is a diagram illustrating an example of a table of POI preference definitions.

FIG. 9 is a flowchart illustrating a process executed by an interest estimation device according to an embodiment of the present invention.

FIG. 10 is a hardware configuration diagram of an interest estimation device according to an embodiment of the present invention.

### DESCRIPTION OF EMBODIMENTS

Hereinafter, a device according to an embodiment will be described in detail with reference to the drawings. In description of the drawings, the same reference signs will be assigned to the same elements, and duplicate description will be omitted. In addition, the embodiment in the following description is a specific example of the present invention, and the present invention is not limited to such an embodiment unless otherwise mentioned.

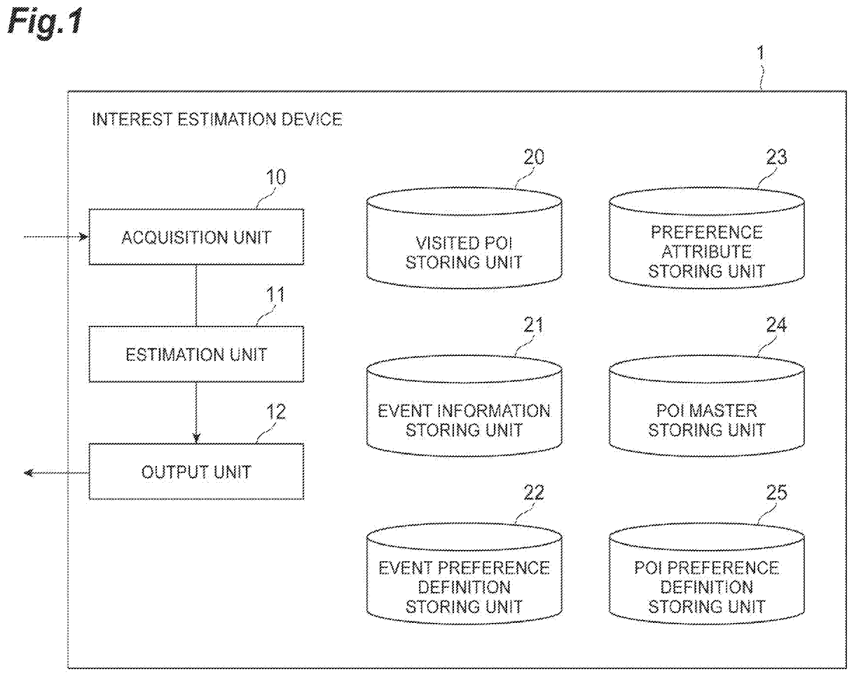

FIG. 1 is a functional block diagram of an interest estimation device 1. As illustrated in FIG. 1, the interest estimation device 1 is configured to include an acquisition unit 10, an estimation unit 11, an output unit 12, a visited POI storing unit 20, an event information storing unit 21, an event preference definition storing unit 22, a preference attribute storing unit 23, a POI master storing unit 24, and a POI preference definition storing unit 25. The interest estimation device 1 is a computer apparatus such as a server or the like.

Hereinafter, each functional block of the interest estimation device 1 illustrated in FIG. 1 will be described.

The acquisition unit 10 acquires visited POI information representing POIs which a user has visited and visit times at which the user visited the POIs. A point of interest (POI) is a specific point (a location, a facility, a store, a target object, or the like) of a user's interest on a map. A timing at which the acquisition unit 10 performs acquisition may be regular (for example, every day at 0:00 hrs) or may be a time when an instruction is given from a manager of the interest estimation device 1 or from another device through a network. The acquisition unit 10 outputs the acquired visited POI information to the estimation unit 11.

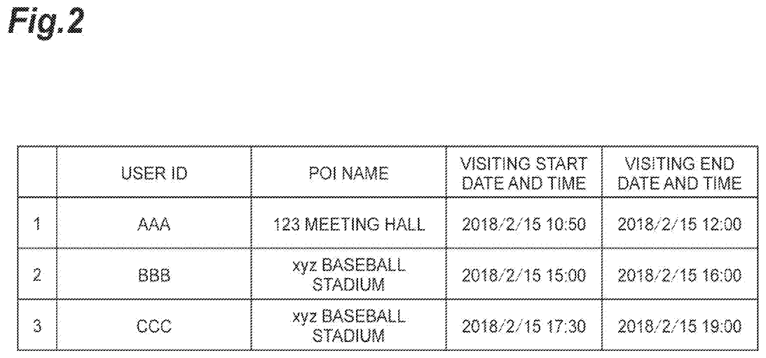

The visited POI storing unit 20 stores table data of visited POIs relating to POIs which a user has visited. FIG. 2 is a diagram illustrating an example of a table of visited POIs. As illustrated in the example of the table illustrated in FIG. 2, a visited POI includes a user ID used for identifying a user, a name of a POI (a POI name) which the user has visited, and a start date and time (a visit start date and time) at which the user visited (stayed) at the POI and an end date and time (a visit end date and time) when the user visited (stayed) at the POI in association with each other. For example, a first record of the visited POIs illustrated in FIG. 2 represents that a user having a user ID “AAA” visited (stayed) at a POI having a POI name “123 meeting hall” from “10:50 on Feb. 15, 2018” to “12:00 on Feb. 15, 2018”.

More specifically, the acquisition unit 10 extracts and acquires visited POI information satisfying predetermined conditions from visited POIs stored using the visited POI storing unit 20. The predetermined conditions may be set in advance or may be included in a received instruction. For example, the acquisition unit 10 acquires visited POI information having a visited time included in “Feb. 15, 2018” for a user whose user ID is “AAA” from visited POIs stored using the visited POI storing unit 20. Hereinafter, for the convenience of description, although it is premised that a process for one designated user is performed in the description, details of the description can be applied also to a process for a plurality of users.

The estimation unit 11 searches for events held at a visiting time represented by the visited POI information at POIs represented by the visited POI information acquired (input) by the acquisition unit 10 and estimates a user's interest on the basis of a result of the search.

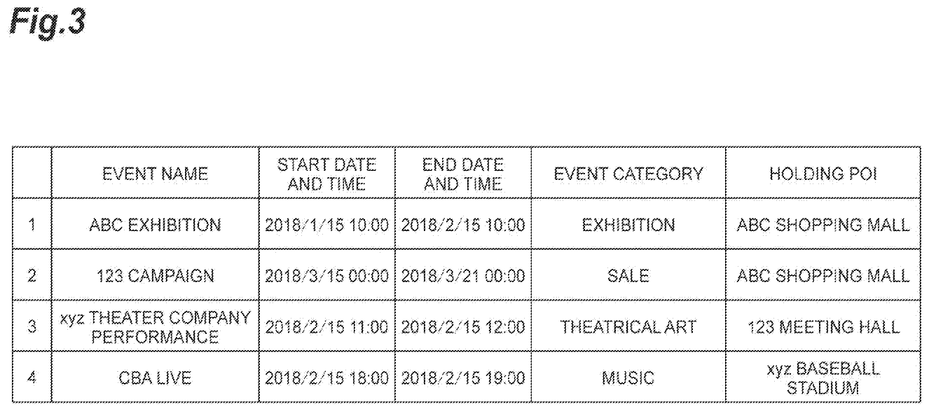

The event information storing unit 21 stores table data of event information relating to events. FIG. 3 is a diagram illustrating an example of a table of event information. As illustrated in the example of the table illustrated in FIG. 3, the event information includes a name of each event (event name), a start date and time of the event, an end date and time of the event, an event category of the event, and a POI in which the event is held (performed) (holding POI) in association with each other. For example, a first record of the event information illustrated in FIG. 3 represents that an event of which an event name is “ABC exhibition” and of which an event category is “exhibition” was held at “ABC shopping mall” from “10 o'clock on Jan. 15, 2018” to “10 o'clock on Feb. 15, 2018”.

At the time of a search, for example, the estimation unit 11 refers to the example of the table of the event information illustrated in FIG. 3 and searches for a record, that is, an event of which a value of a holding POI corresponds to a POI represented by the visited POI information and of which a period (a period in which the event was held) represented by a value of the start date and time and a value of the end date and time overlaps (at least in part) a visiting time represented by the visited POI information.

In a case in which an event has been able to be retrieved, the estimation unit 11 may estimate that the user is interested in the event.

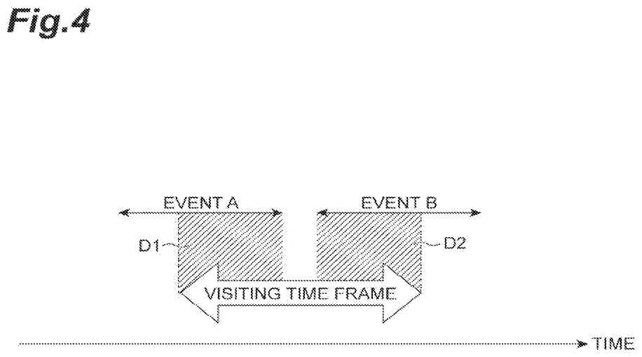

In a case in which events were able to be retrieved, and (a cumulative value of) a time in which holding periods of all the retrieved events and a visiting time represented by the visited POI information overlap each other is equal to or higher than a predetermined proportion (for example, 50%) of the visiting time, the estimation unit 11 may estimate that the user was interested in the events. FIG. 4 is a diagram illustrating overlapping between event holding periods and a visiting time. In FIG. 4, a time in which a holding period of “event A” and a visiting time overlap each other is denoted by D1, and a time in which a holding period of “event B” and a visiting time overlap each other is denoted by D2.

The estimation unit 11 may estimate a degree of user's interest in each of events on the basis of a time in which a holding period of each of the retrieved events and a visiting time represented by the visited POI information overlap each other. For example, in a case in which two events were retrieved, an event category of a first event is “Exhibition” and a time in which a holding period and a visiting time overlap each other is “30 minutes”, and an event category of a second event is “Music” and a time in which a holding period and a visiting time overlap each other is “60 minutes”, the estimation unit 11 estimates that a degree of user's interest in “Exhibition” is “1.0” (as the value becomes larger, this represents that a degree of user's interest becomes higher) and estimates that a degree of user's interest in “Music” is “2.0”.

The estimation unit 11 may estimate a degree of user's interest in each event also on the basis of the scale of each of retrieved events. In other words, the estimation unit 11 may estimate a degree of user's interest in each event on the basis of a time in which a holding period of each retrieved event and a visiting time represented by the visited POI information overlap each other and the scale of each retrieved event. The scale of an event may be the number of participants or the number of mentions thereof on the Internet (the number of words of mouth, the number of postings, the number of Twitter posts, or the like). For example, the estimation unit 11 may determine a degree of user's interest in an event to become higher as the scale of the event becomes larger. For example, in the example of the case in which two events were able to be retrieved described above, in a case in which the number of participants of a first event is “100”, and the number of participants of a second event is “200”, a degree of user's interest in “Exhibition” is estimated to be “1.0”, and a degree of user's interest in “Music” is estimated to be “3.0”.

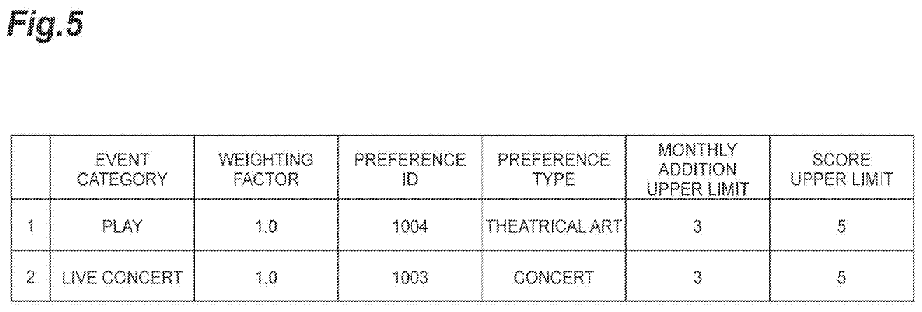

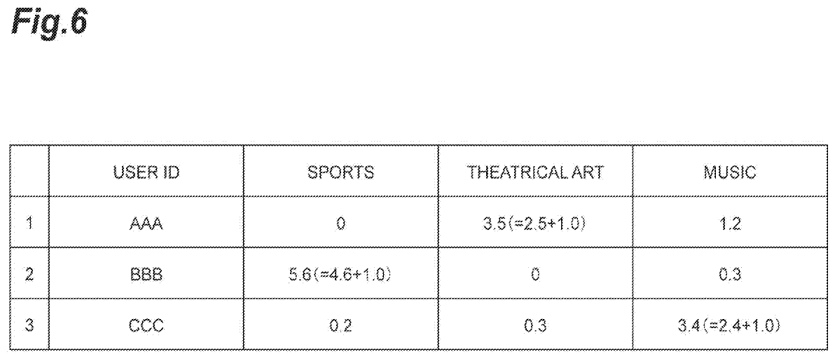

Hereinafter, an example of a method for estimating a degree of user's interest in an event using the estimation unit 11 will be described with reference to FIGS. 5 and 6.

The event preference definition storing unit 22 stores table data of event preference definitions relating to definitions of preferences (interests) for events. FIG. 5 is a diagram illustrating an example of a table of event preference definitions. As illustrated in the example of the table illustrated in FIG. 5, an event preference definition includes an event category, a weighting factor indicating a degree of preference for the event category, a preference ID used for identifying the preference, a preference type that is a type of the preference, a monthly addition upper limit of the degree, and a score upper limit that is an upper limit value of the degree in association with each other. For example, a first record of the event preference definitions illustrated in FIG. 5 represents that a preference for an event category “Play” has a preference type of “Theatrical Art” having a preference ID “1004”, a weighting factor of “1.0”, a monthly addition upper limit of “3”, and a score upper limit of “5”.

The preference attribute storing unit 23 stores table data of preference attributes indicating degrees of preferences (interests) of users. FIG. 6 is a diagram illustrating an example of a table of preference attributes. As illustrated in the example of the table illustrated in FIG. 6, an event preference definition includes a user ID and a degree of preference for (one or more) preference types of a user identified using the user ID in association with each other. For example, a first record of the preference attributes illustrated in FIG. 6 represents that a degree of preference of a user having user ID “AAA” for preference type “Sports” is “0”, a degree of preference for preference type “Theatrical art” is “3.5”, and a degree of preference for preference type “Music” is “1.2”.

The estimation unit 11, for each event that has been retrieved, acquires an event category associated with the event by referring to the event information stored using the event information storing unit 21. Next, the estimation unit 11 acquires a preference type (or a preference ID) and a weighting factor associated with the acquired event category by referring to event preference definitions stored using the event preference definition storing unit 22. Next, the estimation unit 11 updates a degree of preference corresponding to the acquired preference type (or the preference ID) among preference attributes stored using the preference attribute storing unit 23 (for example, adds a value of the weighting factor thereto) on the basis of the acquired weighting factor. In addition, at the time of updating, there are restrictions of the monthly addition upper limit associated with the acquired event category and the score upper limit associated with the acquired event category in the event preference definition. For example, values added within one month must not exceed the monthly addition upper limit, and a value after addition must not exceed the score upper limit.

An example of the method for estimating the degree of user's interest in an event using the estimation unit 11 has been described as above.

The estimation unit 11 may estimate a degree of user's interest in a POI represented by the visited POI information on the basis of a time in which holding periods of all the retrieved events and a visiting time represented by the visited POI information do not overlap each other. In other words, the estimation unit 11 determines that a user is interested in not an event but a POI represented by the visited POI information for a time in which the holding periods and the visiting time do not overlap each other. For example, as will be described below, in a case in which no events were able to be retrieved, the estimation unit 11 estimates that the user is interested in a POI represented by the visited POI information and assumes that a degree of user's interest in the POI at that time is estimated as “2.0”. If the estimation unit 11 could retrieve events, and in a case in which a time in which holding periods of all the retrieved events and a visiting time represented by the visited POI information do not overlap each other is a half of the visiting time, the estimation unit 11 estimates a degree of user's interest in the POI represented by the visited POI information as “1.0” that is a half of “2.0”.

In a case in which no events were able to be retrieved, the estimation unit 11 may estimate that the user is interested in the POI represented by the visited POI information.

In a case in which events are able to be retrieved, and a time in which holding periods of all the retrieved events and a visiting time represented by the visited POI information overlap each other is lower than a predetermined proportion (for example, 50%) of the visiting time, the estimation unit 11 may estimate that the user is interested in the POI represented by the visited POI information.

Hereinafter, an example of a method for estimating a degree of user's interest in a POT using the estimation unit 11 will be described with reference to FIGS. 7 and 8 and FIG. 6 described above.

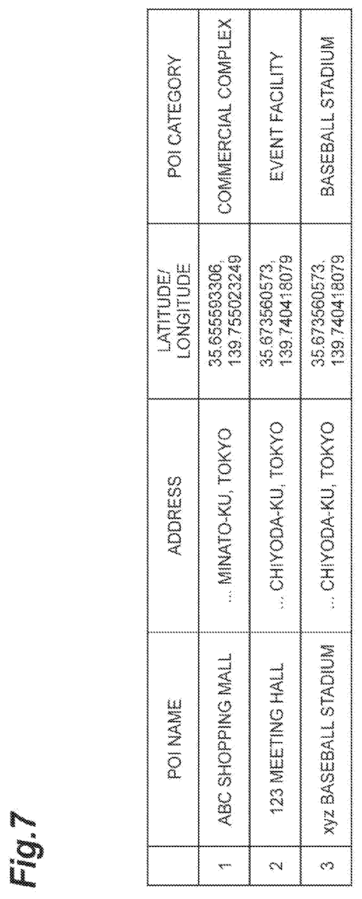

The POI master storing unit 24 stores table data of a POI master that is master data of POIs. FIG. 7 is a diagram illustrating an example of a table of a POI master. As illustrated in the example of the table illustrated in FIG. 7, the POI master stores a name of a POI (a POI name), an address at which the POI is located, a latitude/longitude at which the POI is located, and a POI category of the POI in association with each other. In addition, for example, a first record of the POI master illustrated in FIG. 7 represents that a POI of POI name “ABC shopping mall” has address “. . . Minato-Ku, Tokyo”, latitude/longitude “35.655593306, 139.755023249”, and POI category “Commercial complex”.

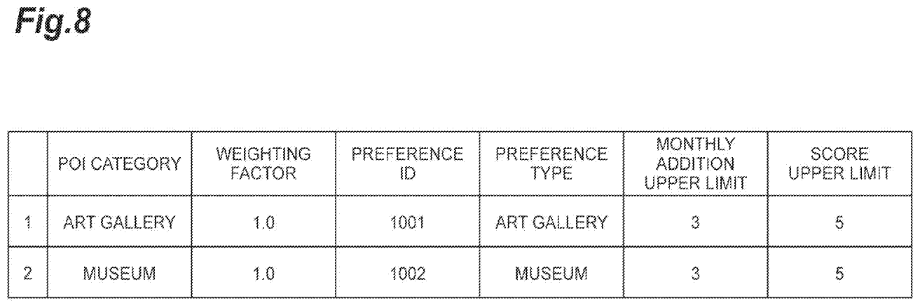

The POI preference definition storing unit 25 stores table data of POI preference definitions relating to definitions of preferences (interests) for each POI. FIG. 8 is a diagram illustrating an example of a table of POI preference definitions. As illustrated in the example of the table illustrated in FIG. 8, a POI preference definition includes a POI category, a weighting factor of a degree of preference for the POI category, a preference ID used for identifying the preference, a preference type that is a type of the preference, a monthly addition upper limit of the degree, and a score upper limit that is an upper limit of the degree in association with each other. For example, a first record of POI preference definitions illustrated in FIG. 8 represents that a preference for POI category “Art museum” has preference type “Art museum” of preference ID “1001”, a weighting factor of “1.0”, a monthly addition upper limit of “3”, and a score upper limit of “5”.

The estimation unit 11, for a POI represented by the visited POI information, acquires a POI category associated with the POI by referring to the POI master stored using the POI master storing unit 24. Next, the estimation unit 11 acquires a preference type (or a preference ID) and a weighting factor associated with the acquired POI category by referring to the POI preference definitions stored using the POI preference definition storing unit 25. Next, the estimation unit 11 updates a degree of preference corresponding to the acquired preference type (or the preference ID) among preference attributes stored using the preference attribute storing unit 23 on the basis of the acquired weighting factor (for example, adds a value of the weighting factor thereto). In addition, at the time of updating, in the POI preference definitions, there are restrictions of the monthly addition upper limit associated with the acquired POI category and the score upper limit associated with the acquired POI category. For example, a value added within one month must not exceed the monthly addition upper limit, and a value after addition must not exceed the score upper limit.

The output unit 12 outputs a result of the estimation acquired by the estimation unit 11 to another device through a network or displays the result on the display of the interest estimation device 1.

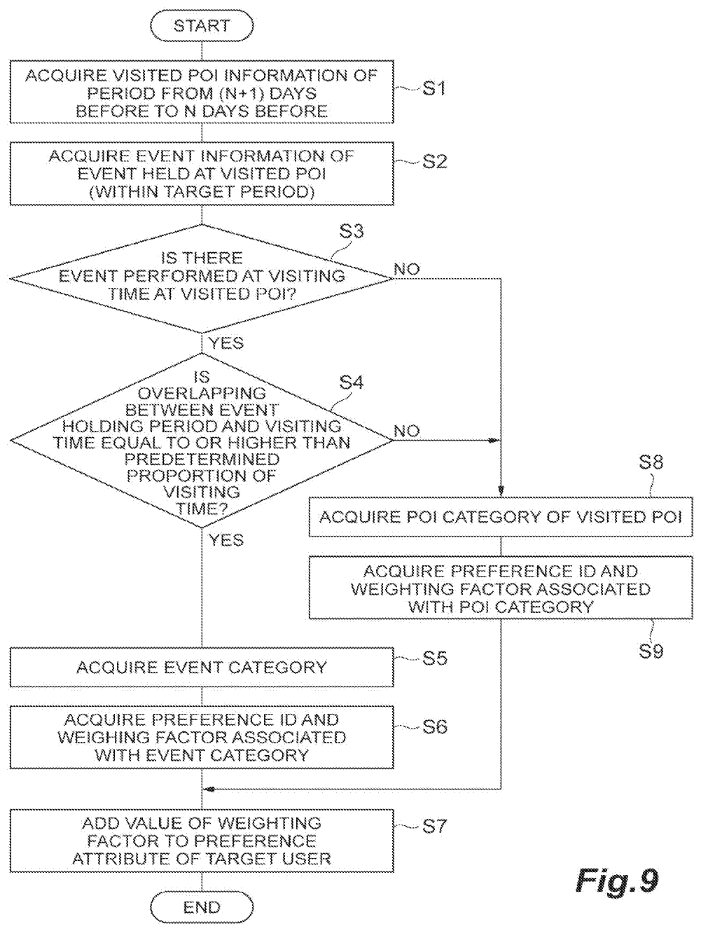

Next, the process of the interest estimation method used by the interest estimation device 1 according to this embodiment will be described with reference to a flowchart illustrated in FIG. 9. In the flowchart illustrated in FIG. 9, different from the description presented above, a process of performing processes for one or more users being performed together will be described.

First, visited POI information of which a visiting time is included in a period from (N+1) days before to N days before (here, N is an integer that is equal to or larger than “0”) that is a target period is acquired by the acquisition unit 10 (Step S1). Next, event information relating to events held at a POI represented by each piece of visited POI information acquired in S1 within the target period is acquired (events are retrieved) by the estimation unit 11 (Step S2). Next, it is determined whether or not there is an event performed at a visiting time represented by the visited POI information at a POI represented by each piece of visited POI information by referring to the event information acquired in S2 by the estimation unit 11 (Step S3). When it is determined that there is an event in S3 (S3: Yes), next, it is determined by the estimation unit 11 whether or not an overlap between an event holding period and a visiting time is equal to or higher than a predetermined proportion of the visiting time (Step S4). When it is determined that an overlap is equal to or higher than the predetermined proportion in S4 (S4: Yes), next, by using the estimation unit 11, an event category of the retrieved event is acquired (Step S5), a preference ID and a weighting factor associated with the acquired event category are acquired (Step S6), and a weighting factor acquired for the degree of preference corresponding to the acquired preference ID among preference attributes of a user who is a current target is added (Step S7).

On the other hand, when it is determined that there are no events in S3 (S3: No), or when it is determined that an overlap is lower than the predetermined proportion in S4 (S4: No), a POI category of a POI represented by the visited POI information is acquired (Step S8), a preference ID and a weighting factor associated with the acquired POI category are acquired (Step S9), and a weighting factor acquired for the degree of preference corresponding to the acquired preference ID among preference attributes of a user who is a current target is added (Step S7).

Next, operations and effects of the interest estimation device 1 configured as in this embodiment will be described.

According to the interest estimation device 1 of this embodiment, a user's interest is estimated on the basis of POIs visited by the user and a result of a search for events that were held at visiting times at which the POIs were visited. For example, in a case in which an event was able to be retrieved, the user is estimated to be interested in the event, and, in a case in which no event was able to be retrieved, the user is estimated to be interested in the visited POI. In this way, it can be estimated whether a user is interested in an event or a POI or the like, and a user's interest can be estimated more accurately.

In addition, according to the interest estimation device 1 of this embodiment, in a case in which events were able to be retrieved, and a time in which holding periods of all the retrieved events and a visiting time represented by the visited POI information overlap each other is equal to or higher than a predetermined proportion of the visiting time, the estimation unit 11 may estimate that the user is interested in the event. In this way, for example, in a case in which a user participates in an event for a certain degree of time, the user can be estimated to be interested in the event, and accordingly, a user's interest can be estimated more accurately in accordance with an actual situation.

In addition, according to the interest estimation device 1 of this embodiment, on the basis of a time in which a holding period of each retrieved event and a visiting time represented by the visited POI information overlap each other, the estimation unit 11 may estimate a degree of a user's interest in each event. In this way, a degree of user's interest can be estimated on the basis of a time in which the user actually participates in the event, and thus, the user's interest can be estimated more accurately in accordance with an actual situation.

In addition, according to the interest estimation device 1 of this embodiment, the estimation unit 11 may estimate a degree of user's interest in each event also on the basis of the scale of each event that has been retrieved. In this way, when a degree of user's interest is estimated, the scale of an event in which the user participated can be taken into account.

In addition, according to the interest estimation device 1 of this embodiment, on the basis of a time in which holding periods of all the retrieved events and a visiting time represented by the visited POI information do not overlap each other, the estimation unit 11 may estimate a degree of user's interest in a POI represented by the visited POI information. In this way, for example, in a time in which the user does not participate in an event, it can be estimated that the user is not interested in the event but is interested in the POI represented by the visited POI information, and accordingly, a user's interest can be estimated more accurately in accordance with an actual situation.

In addition, according to the interest estimation device 1 of this embodiment, in a case in which events were able to be retrieved, and a time in which holding periods of all the retrieved events and a visiting time represented by the visited POI information overlap each other is lower than a predetermined proportion of the visiting time, the estimation unit 11 may estimate that the user is interested in a POI represented by the visited POI information. In this way, for example, in a case in which a user did not participate in an event for a certain degree of time, it can be estimated that the user is not interested in the event but is interested in the POI represented by the visited POI information, and accordingly, a user's interest can be estimated more accurately in accordance with an actual situation.

Here, as a background, it is conventionally known that POIs/events recommended from POIs that are frequently visited or genres of events are recommended. In addition, as an existing technology, it is known that, from a behavior history (including location information), POIs and events having high visiting frequencies are identified, POIs and events of the same genre are recommended, or visited POIs and events of a user clustered in the same behavior pattern are recommended. However, there is a problem in that it cannot be determined whether a user is interested in an event or a POI. When there is a visiting log for a corresponding POI in a period in which an event was held, the interest estimation device 1 according to this embodiment determines that the user is interested in the genre of the event. On the other hand, in a case in which there was no event, it is determined that the user is interested in the genre of the POI. For example, in a case in which a user stayed at a POI while a music live event was held at a Yoyogi gym, the user is estimated to be interested in music. According to the interest estimation device 1 of this embodiment, an accuracy of estimation of a preference based on a behavior history can be improved.

The block diagrams used in the description of the embodiment described above represent blocks in functional units. Such functional blocks (constituent units) are realized by an arbitrary combination of hardware and/or software. In addition, a means that realizes each functional block is not particularly limited. In other words, each functional block may be realized by one device that is combined physically and/or logically or may be realized by directly and/or indirectly (for example, in a wired manner and/or a wireless manner) connecting two or more devices that are separated physically and/or logically and using the plurality of devices.

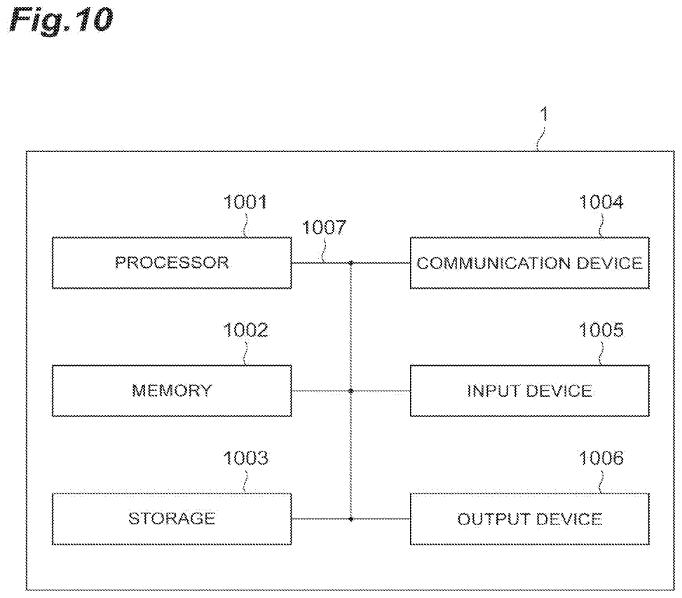

For example, the interest estimation device 1 and the like according to one embodiment of the present invention may function as a computer that performs the process of the interest estimation method according to one embodiment of the present invention. FIG. 10 is a diagram illustrating one example of the hardware configuration of the interest estimation device 1 according to one embodiment of the present invention. The interest estimation device 1 described above may be physically configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the interest estimation device 1 may be configured to include one or a plurality of devices illustrated in the drawings or may be configured not to include some of the devices.

Each function of the interest estimation device 1 is realized by the processor 1001 performing an arithmetic operation and controlling communication using the communication device 1004 and data reading and/or writing for the memory 1002 and the storage 1003 by causing the processor 1001 to read predetermined software (a program) onto hardware such as the memory 1002 or the like.

The processor 1001, for example, controls the entire computer by operating an operating system. The processor 1001 may be configured by a central processing unit (CPU) including an interface with peripheral devices, a control device, an arithmetic operation device, a register, and the like. For example, the acquisition unit 10, the estimation unit 11, the output unit 12, and the like described above may be realized by the processor 1001.

In addition, the processor 1001 reads a program (program code), a software module, and data from the storage 1003 and/or the communication device 1004 into the memory 1002 and executes various processes in accordance with this. As the program, a program causing the computer to execute at least some of the operations described in the embodiment described above is used. For example, the acquisition unit 10, the estimation unit 11, and the output unit 12 may be realized by a control program that is stored in the memory 1002 and is operated by the processor 1001, the other functional blocks may be similarly realized. While various processes described above have been described as being executed by one processor 1001, the processes may be executed by two or more processors 1001 simultaneously or sequentially. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable to perform the interest estimation method according to one embodiment of the present invention.

The storage 1003 is a computer-readable recording medium and, for example, may be configured by at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including the memory 1002 and/or storage 1003, a server, or any other appropriate medium.

The communication device 1004 is hardware (a transmission/reception device) for performing inter-computer communication through a wired and/or wireless network and, for example, may also be called as a network device, a network controller, a network card, a communication module, or the like. For example, the acquisition unit 10, the output unit 12, and the like may be realized by the communication device 1004.

The input device 1005 is an input device (for example, a keyboard, a mouse, a microphone, a switch, a button, a sensor, or the like) accepting an input from the outside. The output device 1006 is an output device (for example, a display, a speaker, an LED lamp, or the like) performing output to the outside. In addition, the input device 1005 and the output device 1006 may have an integrated configuration (for example, a touch panel).

In addition, devices such as the processor 1001, the memory 1002, and the like are interconnected through a bus 1007 for communication of information. The bus 1007 may be configured as a single bus or may be configured using buses different for devices.

In addition, the interest estimation device 1 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by hardware. For example, the processor 1001 may be realized using at least one of such hardware components.

The notification of information is not limited to the aspect/embodiment described in this specification and may be performed using any other method.

Each aspect/embodiment described in the present specification may be applied to long term evolution (LTE), LTE-advanced (LTE-A), Super 3G, IMT-advanced, 4G, 5G future ratio access (FRA), W-CDMA (Registered trademark), GSM (registered trademark), CDMA 2000, ultra mobile broadband (UMB), IEEE 802.11 (Wi-Fi), IEEE 802.16 (WiMAX), IEEE 802.20, ultra-wideband (UWB), Bluetooth (registered trademark), a system using another appropriate system and/or a next generation system extended based on these.

The processing sequence, the sequence, the flowchart, and the like of each aspect/embodiment described in the present specification may be changed in order as long as there is no contradiction. For example, in a method described in the present specification, elements of various steps are presented in an exemplary order, and the method is not limited to the presented specific order.

Information and the like may be output from an upper layer (or a lower layer) to a lower layer (or an upper layer). The information and the like may be input and output through a plurality of network nodes.

The input/output information and the like may be stored in a specific place (for example, a memory) or managed using a management table. The input/output information and the like may be overwritten, updated, or additionally written. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present specification may be individually used, used in combination, or be switched therebetween in accordance with execution. In addition, a notification of predetermined information (for example, a notification of being X) is not limited to be performed explicitly and may be performed implicitly (for example, a notification of the predetermined information is not performed).

As above, while this embodiment has been described in detail, it is apparent to persons skilled in the art that this embodiment is not limited to the embodiments described in this specification. This embodiment can be performed as a modified and changed aspect without departing from the concept and the scope of the present invention defined by the claims. Thus, description of this specification is for the purpose of exemplary description and does not have any meaning for limiting this embodiment.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, and the like may be transmitted and received via a transmission medium. For example, in a case in which software is transmitted from a website, a server, or any other remote source using wiring technologies such as a coaxial cable, an optical fiber cable, a twisted pair, a digital subscriber line (DSL) and the like and/or radio technologies such infrared rays, radio waves, and microwaves, and the like, such wiring technologies and/or radio technologies are included in the definition of the transmission medium.

Information, a signal, and the like described in the present specification may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

In addition, a term described in the present specification and/or a term that is necessary for understanding the present specification may be substituted with terms having the same meaning or a meaning similar thereto.

Terms “system” and “network” used in the present specification are compatibly used.

In addition, information, a parameter, and the like described in the present specification may be represented using absolute values, relative values from predetermined values, or other corresponding information.

A name used for each parameter described above is not limited in any aspect. In addition, numerical equations and the like using such parameters may be different from those that are explicitly disclosed in this specification.

Terms such as “determining” used in this specification may include various operations of various types. The “determining,” for example, may include a case in which judging, calculating, computing, processing, deriving, investigating, looking up (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining.” Furthermore, “determining” may include a case in which resolving, selecting, choosing, establishing, comparing, or the like is regarded as “determining ” In other words, “determining” includes a case in which a certain operation is regarded as “determining.”

Terms such as “connected” or “coupled” or all the modifications thereof mean all the kinds of direct or indirect connection or coupling between two or more elements and may include presence of one or more intermediate elements between two elements that are mutually “connected” or “coupled.” Coupling or connection between elements may be physical coupling or connection, logical coupling or connection, or a combination thereof. When used in this specification, two elements may be conceived as being mutually “connected” or “coupled” by using one or more wires, cables and/or print electric connections and, as several non-limiting and non-comprehensive examples, by using electromagnetic energy such as electromagnetic energy having wavelengths in a radio frequency region, a microwave region, and a light (both visible light and non-visible light) region.

Description of “on the basis of” used in this specification does not mean “only on the basis of” unless otherwise mentioned. In other words, description of “on the basis of” means both “only on the basis of” and “at least on the basis of.”

In this specification, in a case in which names such as “first,” “second,” and the like are used, referring to each element does not generally limit the amount or the order of such an element. Such names may be used in this specification as a convenient way for distinguishing two or more elements from each other. Accordingly, referring to the first and second elements does not mean that only the two elements are employed therein or the first element should precede the second element in a certain form.

In addition, a “means” in the configuration of each device described above may be replaced with a “unit,” a “circuit,” a “device,” or the like.

As long as “including,” “comprising,” and modifications thereof are used in this specification or the claims, such terms are intended to be inclusive like a term “comprising.” In addition, a term “or” used in this specification or the claims is intended to be not an exclusive logical sum.

In the entire disclosure, for example, in a case in which articles such as “a,” “an” and “the” in English are added through translation, as long as such articles are not clear on the basis of the context, those include plural forms.

### REFERENCE SIGNS LIST

1 interest estimation device

10 acquisition unit

11 estimation unit

12 output unit

20 visited POI storing unit

21 event information storing unit

22 event preference definition storing unit

23 preference attribute storing unit

24 POI master storing unit

25 POI preference definition storing unit

1. An interest estimation device comprising a circuitry configured to:
acquire visited POI information representing a point of interest (POI) which a user visited and a visiting time at which the POI is visited; and
search for one or more events that were held at the POI represented by the acquired visited POI information and at the visiting time represented by the visited POI information and estimate a user's interest on the basis of a result of the search.

2. The interest estimation device according to claim 1, wherein, in a case in which one or more events were able to be retrieved, or in a case in which one or more events were able to be retrieved and a time in which holding periods of all the retrieved one or more events and the visiting time represented by the visited POI information overlap each other is equal to or higher than a predetermined proportion of the visiting time, the circuitry estimates that the user is interested in the one or more events.

3. The interest estimation device according to claim 2, wherein, on the basis of a time in which a holding period of each one or more events that has been retrieved and the visiting time represented by the visited POI information overlap each other, the circuitry estimates a degree of the user's interest in each one or more events.

4. The interest estimation device according to claim 3, wherein the circuitry estimates the degree of the user's interest in each one or more events also on the basis of a scale of each one or more events that has been retrieved.

5. The interest estimation device according to claim 2, wherein the circuitry estimates a degree of the user's interest in the POI represented by the visited POI information on the basis of the time in which holding periods of all the one or more events that have been retrieved and the visiting time represented by the visited POI information do not overlap each other.

6. The interest estimation device according to claim 1, wherein, in a case in which an event was not able to be retrieved or in a case in which one or more events were able to be retrieved and the time in which holding periods of all the retrieved one or more events and the visiting time represented by the visited POI information overlap each other is lower than a predetermined proportion of the visiting time, the circuitry estimates that the user is interested in the POI represented by the visited POI information.

7. The interest estimation device according to claim 3, wherein the circuitry estimates a degree of the user's interest in the POI represented by the visited POI information on the basis of the time in which holding periods of all the one or more events that have been retrieved and the visiting time represented by the visited POI information do not overlap each other.

8. The interest estimation device according to claim 4, wherein the circuitry estimates a degree of the user's interest in the POI represented by the visited POI information on the basis of the time in which holding periods of all the one or more events that have been retrieved and the visiting time represented by the visited POI information do not overlap each other.
